(19) United States
(12) Patent Application Publication
(10) Pub. No.: US 2008/0176044 A1
(43) Pub. Date: Jul. 24, 2008

(54) WINDOW FOR ACID-BASE TANK

(75) Inventors: Chi-Chuan Lee, Kaohsiung City (TW); Chih-Ming Chen, Hsinchu City (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/624,883

(22) Filed: Jan. 19, 2007

(51) Int. Cl. G01F 23/02

(52) U.S. Cl. 428/192; 134/113

(57) ABSTRACT

A window for an acid-base tank suitable for arrangement on a cleaning machine including at least one acid-base tank with an opening on a sidewall of the acid-base tank is described. The window for the acid-base tank at least includes a supporting plate, an annular washer, a transparent observe window and a transparent separation plate. The supporting plate has the same shape as the opening on the sidewall of the cleaning machine, is disposed on the opening, and has a first window opening. The annular washer is disposed on the supporting plate around the first window opening. The transparent observe window is pressed and covered on the annular washer. The transparent separation plate located between the supporting plate and the acid-base tank is disposed on the supporting plate and covers the first window opening. Furthermore, the chemical resistance of the transparent separation plate is better than that of quartz.

### BACKGROUND OF THE INVENTION

1. Field of the Invention

The present invention relates to components of a washing machine. More particularly, the present invention relates to a refined window for an acid-base tank.

2. Description of Related Art

Based on current semiconductor process technology, every wafer is made with hundreds of steps. Among the steps, a wafer cleaning process is the most frequent and complicated step. Generally, the wafer cleaning process includes removal of the bad particles, oxide layers and metal layers. In semitool, CP1 and CP2 are cleaning tanks, and SRD is a DI water cleaning tank.

One of the problems that often occur when wafers are washed by washing machines is the uncertainty of the washing condition inside the machine. Therefore, a window is disposed on the washing machine to observe the inner conditions. Moreover, sensors are utilized to observe the washing conditions through the window. Currently, the windows of the washing machines are made of quartz due to its high transparency and excellent mechanical properties.

However, in wafer cleaning practice, damages of machine components made by a cleaning solution is identified when maintaining the machine. Particularly, the window made of quartz needs to be replaced because it is corroded by strong acid or strong base cleaning solution. As mentioned above, the corrosion problem of the quartz-made window results in the overflow of the cleaning solution, which seriously affects the life of the operators. Consequently, to avoid the overflow problem of the cleaning solution, the window needs to be replaced every 2-3 months and significantly increases the process cost.

### SUMMARY OF THE INVENTION

Accordingly, the present invention provides a window for an acid-base tank which is capable of avoiding the corrosion problem of a cleaning machine window, extending the life span of the window for the acid-base tank and reducing the process cost.

The present invention provides a window for an acid-base tank which is suitable to be disposed on a cleaning machine. At least one acid-base tank having an opening on a side wall is disposed on the cleaning machine. The window for the acid-base tank of the present invention includes at least a supporting plate, an annular masher, a transparent observe window and a transparent separation plate. The shape of the openings on the sidewall of the acid-base tank and that of the supporting plate are the same. The supporting plate having a first window opening is disposed on the opening. The annular washer is disposed on the supporting plate around the first window opening. The transparent observe window is pressed and covered on the annular washer. The transparent separation plate, located between the supporting plate and the acid-base tank, is disposed on the supporting plate and covers the first window opening. Moreover, the chemical resistance of the transparent separation plate is better than that of quartz.

In accordance with the window for the acid-base tank described in one embodiment of the present invention, the material of the transparent separation plate is, for example, fluoride resin material.

In accordance with the window for the acid-base tank described in one embodiment of the present invention, the method of disposing the transparent separation plate on the supporting plate is, for example, an adhering method or a coating method.

In accordance with the window for the acid-base tank described in one embodiment of the present invention, the material of the transparent separation plate is, for example, quartz or glass.

In accordance with the window for the acid-base tank described in one embodiment of the present invention, the window for the acid-base tank can further include a cover plate and an elastic connection part. The cover plate is disposed above the transparent observe window and had a second window opening which corresponds to the first window opening. Moreover, the elastic connection part is connected the first window opening and the second window opening.

Furthermore, the present invention provides a window for an acid-base tank which is suitable to be disposed on a cleaning machine. At least one acid-base tank having an opening on the sidewall is disposed on the cleaning machine. The window for the acid-base tank includes at least a supporting plate, an annular washer and a transparent observe window. The shape of the supporting plate is the same as that of the opening. The supporting plate is disposed on the sidewall opening of the acid-base tank and has a first window opening. The annular washer, with chemical resistance, is disposed on the supporting plate around the first window opening. The transparent observe window is pressed and covered on the top of the annular washer. Furthermore, the chemical resistance of the transparent observe window adjacent to a side of the opening surface is better than that of quartz.

In accordance with the window for the acid-base tank described in one embodiment of the present invention, the material of the transparent separation plate is, for example, fluoride resin material.

In accordance with the window for the acid-base tank described in one embodiment of the present invention, the transparent observe window includes a transparent body and a transparent film covering the transparent body. The chemical resistance of the transparent film is better than that of quartz. For example, the material of the transparent film is fluoride resin material, and the material of the transparent body is made of quartz or glass. Moreover, the method of covering the transparent film on the transparent body is, for example, an adhering method or a coating method.

In accordance with the window for the acid-base tank described in one embodiment of the present invention, the material of the above-mentioned annular washer is, for example, plastic material fully-coated with fluoride.

In accordance with the window for the acid-base tank described in one embodiment of the present invention, the window for the acid-base tank can further include a cover plate and an elastic connection part. The cover plate is disposed above the transparent observe window and has a second window opening which corresponds to the first window opening. Moreover, the elastic connection part is connected the first window opening and the second window opening.

The present invention further provides a window for an acid-base tank which is suitable to be disposed on a cleaning machine. At least one acid-base tank having an opening on the sidewall is disposed on the cleaning machine. A transparent observe window in the window for the acid-base tank disposed on opening of the sidewall of the window for the acid-base tank. The shapes of the transparent observe window and the opening are the same. Furthermore, the transparent observe window includes a first portion and a second portion. The first portion connects the sidewall of the acid-base tank around the opening. The first portion having a first window opening is connected the second portion at the position of the first window opening. Moreover, the chemical resistance of the transparent separation plate is better than that of quartz.

In accordance with the window for the acid-base tank described in one embodiment of the present invention, the window for the acid-base tank can further include a supporting plate disposed on the transparent observe window.

In accordance with the window for the acid-base tank described in one embodiment of the present invention, the material of the window for the acid-base tank is fluoride resin material, for example.

In accordance with the window for the acid-base tank described in one embodiment of the present invention, the transparent observe window is integrally formed.

In accordance with the window for the acid-base tank described in one embodiment of the present invention, the window for the acid-base tank can further include a cover plate and an elastic connection part. The cover plate is disposed above the transparent observe window and has a second window opening which corresponds to the first window opening. Moreover, the elastic connection part is connected the first window opening and the second window opening.

The refined window for the acid-base tank provided in the present invention is capable of preventing the window from being corroded by strong acid or strong base cleaning solution, which causes the overflow of the cleaning solution and affects the process efficiency. On the other hand, the present invention extends the lifetime of the window for the acid-base tank and significantly lower the process cost.

Several embodiments accompanied with figures are described in detail in the following to present the above-mentioned and other disclosures, features and advantages of the present invention.

### BRIEF DESCRIPTION OF THE FIGURES

FIG. 1 is an exploded schematic view of a window for an acid-base tank in accordance with a first embodiment of the present invention.

FIG. 2 is a schematic view of a transparent separation plate drawn in accordance with one embodiment of the present invention.

FIG. 3 is an exploded schematic view of the window for the acid-base tank in accordance with a second embodiment of the present invention.

FIG. 4 is a schematic view of a transparent observe window in accordance with one embodiment of the present invention.

FIG. 5 is a schematic view of the transparent observe window in accordance with another embodiment of the present invention.

FIG. 6 is a schematic view of the window for the acid-base tank drawn in accordance with a third embodiment of the present invention.

FIG. 7A and FIG. 7B are schematic views of a supporting plate in accordance with another embodiment of the present invention.

FIG. 8 is a schematic view of the window for the acid-base tank in accordance with another embodiment of the present invention.

### DESCRIPTION OF EMBODIMENTS

A window for an acid-base tank in the present invention is suitable for being applied to cleaning machines used by semiconductor manufacturers and photo-electronic factories . . . etc, and related high-tech industry. The window for the acid-base tank can avoid the corrosion of the window by strong acid or strong base solutions so as to cause the overflow of cleaning solutions and affects the process efficiency. Moreover, the present invention extends the lifetime of the window for the acid-base tank and significantly lower the process cost. In addition, the window for an acid-base tank can surely be applied to other industries, such as chemical engineering industries, petroleum industries, pharmacy industries, textile industries and food industries.

In the following, several embodiments are listed to illustrate the window for the acid-base tank in the present invention. In all the embodiments, all the examples are based on the condition that the window for the acid-base tank is disposed on the cleaning machines used by semiconductor manufacturers.

### The First Embodiment

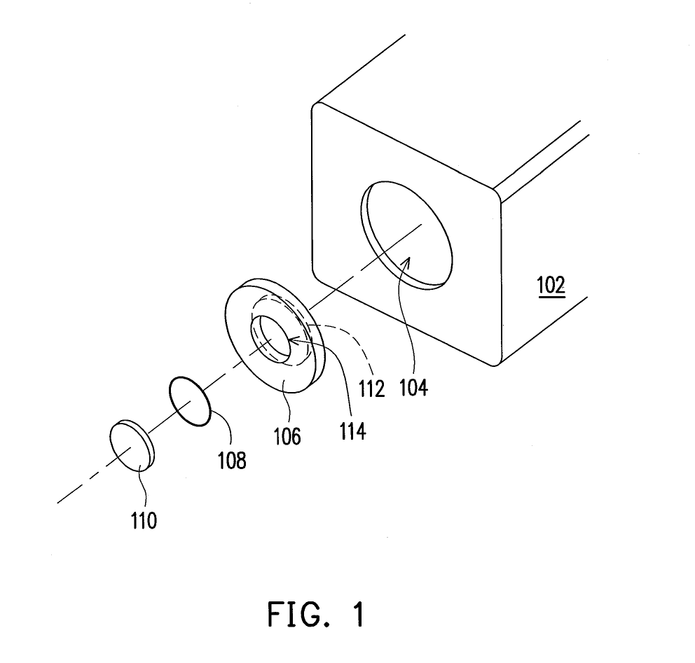

FIG. 1 is an exploded schematic view of a window for an acid-base tank in accordance with the first embodiment of the present invention.

Generally, at least one acid-base tank 102 is disposed on cleaning machines used by semiconductor manufacturers. The amount of the acid-base tanks can be adjusted according to the process demand. An opening 104 on a sidewall of the acid-base tank 102 is used to observe the internal condition of the acid-base tank 102. Usually, the shape of the opening 104 is circular; however, no particular shapes of the opening 104 are limited in the present invention. The shapes of the openings vary in accordance with the different machines.

The window for the acid-base tank in the embodiment includes a supporting plate 106, an annular washer 108, a transparent observe window 110 and a transparent separation plate 112. The shape of the supporting plate 106 is the same as that of the opening 104 on the sidewall of the acid-base tank 102. The supporting plate 106 having a first window opening 114 is disposed on the opening 104. The supporting plate 106 is, for example, a metal plate or a metal plate with a plastic plate on the top. In addition, the supporting plate 106 can be the supporting plates used in ordinary cleaning machines.

Besides, the transparent separation plate 112 is located between the supporting plate 106 and the acid-base tank 102 and disposed on the supporting plate 106 and covers the first window opening 114. Moreover, the chemical resistance of the transparent separation plate 112 is better than quartz. In other words, the ability of the transparent separation plate 112 to resist acid, base, salt, solutions and other chemicals is better than quartz. The material of the transparent separation plate 112 is, for example, fluoride resin material which is Teflon or PFA. As mentioned above, the method of disposing the transparent separation plate 112 on the supporting plate 106 is, for example, cutting a whole piece of a fluoride resin material for the applicable size as the transparent separation plate 112. Then, the transparent separation plate 112 is adhered to or coated on the supporting 106.

The annular washer 108 is disposed on the supporting plate 106 around the first window opening 114. The annular washer 108 can be a general rubber washer. In the embodiment, the transparent observe window 110 is pressed and covered on the annular washer 108. The transparent observe window 110 can be a quartz observe window used in general cleaning machines. The material of the transparent observe window 110 is, for example, glass or other transparent substances.

In the embodiment, the transparent separation plate 112 which directly contacts the cleaning solutions is disposed on the window for the acid-base tank so that the transparent observe window 110 and the annular washer 108 can avoid corroding by the cleaning solutions.

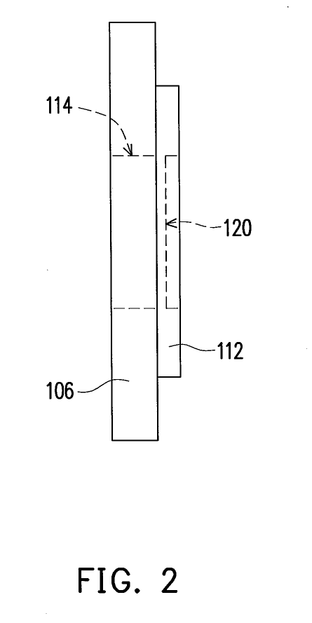

Moreover, the thickness of the transparent separation plate 112 which corresponds to the first window opening 114 in the present embodiment can be thinned (Refer to FIG. 2, area 120). Therefore, it is easier to clearly observe the internal condition through the window for the acid-base tank 102 in the embodiment. As mentioned above, the method of thinning the thickness of the partial area of the transparent separation plate 112 is, for example, milling machine process.

### The Second Embodiment

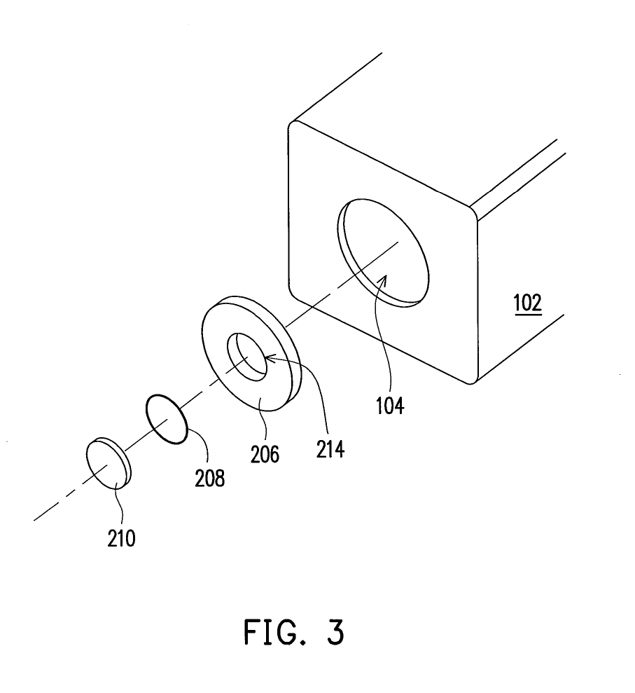

Please refer to FIG. 3. FIG. 3 is an exploded schematic view of a window for an acid-base tank drawn in accordance with a second embodiment of the present invention. In the embodiment, the window for the acid-base tank mainly includes a supporting plate 206, an annular washer 208 and a transparent observe window 210. The shape of an opening 104 on the sidewall of the acid-base tank 102 is the same as that of the supporting plate 206. The supporting plate 206 having a first window opening 214 is disposed on the opening 104. The supporting plate 206 is, for example, a metal plate or a metal plate with a plastic plate on the top. In addition, the supporting plate 206 can also be the supporting plate used in general cleaning machines.

The annular washer 208 in the embodiment is disposed on the supporting plate 206 around the first window opening 214. The transparent observe window 210 is pressed and covered on the annular washer 208. Additionally, the annular washer 208 is chemical-resistant and it can be made of plastic material fully-coated with fluoride. Moreover, the chemical resistance of the surface of the transparent observe window 210 adjacent to the opening 104 is better than that of quartz. Therefore, the corrosion caused by the cleaning solutions can be avoided.

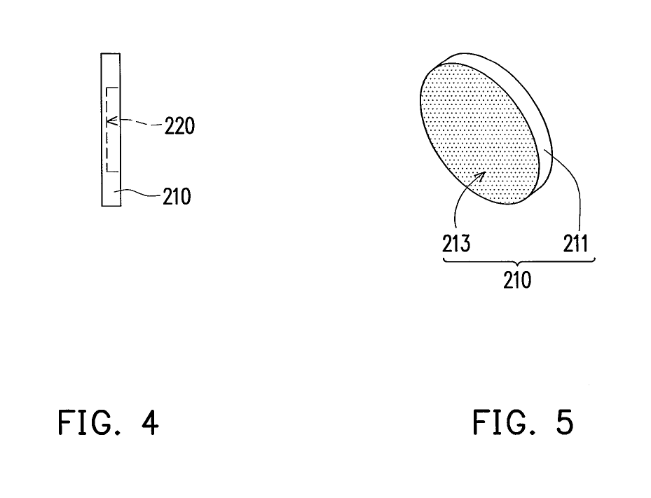

Particularly, the transparent observe window 210 in the embodiment can be directly made of, for example, fluoride resin material. The material for the fluoride resin material is, for example, Teflon or PFA. The fabrication method of the transparent observe window 210 can be, for example, cutting the whole piece of fluoride resin material for an applicable size as the transparent observe window 210. In the embodiment, the thickness of partial area of the transparent observe window 210 can be thinned (Refer to FIG. 4, area 220) to obtain a clearer observation of the internal condition of the acid-base tank 102. As mentioned above, the method of thinning the thickness of the partial area of the transparent observe window 210 is, for example, milling machine process.

Additionally, as shown in FIG. 5, the transparent observe window 210 is composed of, for example, a transparent film 213 and a transparent body 211. The transparent body 211 can be a quartz observe window of a general cleaning machine. In addition, it can be made of, for example, glass or other transparent materials. Moreover, the transparent film 213 covers at least the transparent body 211 near the opening 104. The chemical resistance of the transparent film 213 is better than that of quartz. The material for the transparent film 213 is, for example, fluoride resin materials, such as Teflon or PFA. The method of covering transparent film 213 on the transparent body 211 is, for example, an adhering method or a coating method. Moreover, the transparent film 213 can be covered on the whole transparent body 211 (not shown).

### The Third Embodiment

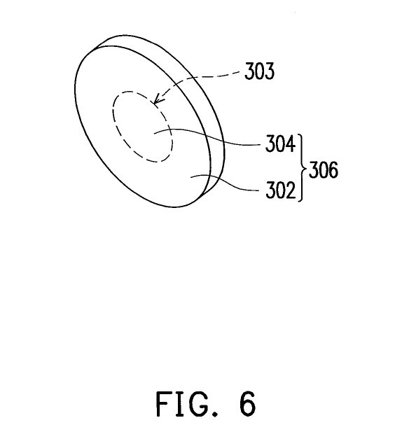

FIG. 6 is a schematic view of a window for an acid-base tank in accordance with the third embodiment of the present invention.

Please refer to FIG. 6. The present embodiment includes a transparent observe window 306 disposed on an opening 104 on the sidewall of an acid-base tank 102. The transparent observe window 306 is integrally formed with better chemical resistance than quartz. The transparent observe window 306 is made of, for example, fluoride resin materials, such as Teflon or PFA. The transparent observe window 306 includes a first portion 302 and a second portion 304. The first portion 302 having a first window opening 303 is connected a sidewall of the acid-base tank 102 around the opening 104. The second portion 304 is located in the area of the first window opening 303 and is connected the first portion 302.

Moreover, to obtain a clearer observation of the internal condition of the acid-base tank 102 through the window for the acid-base tank in the embodiment, a thickness of the second portion 304 of the transparent observe window 306 can be thinned. As mentioned above, a method of thinning the thickness of the second portion 304 of the transparent observe window 306 is, for example, milling machine process.

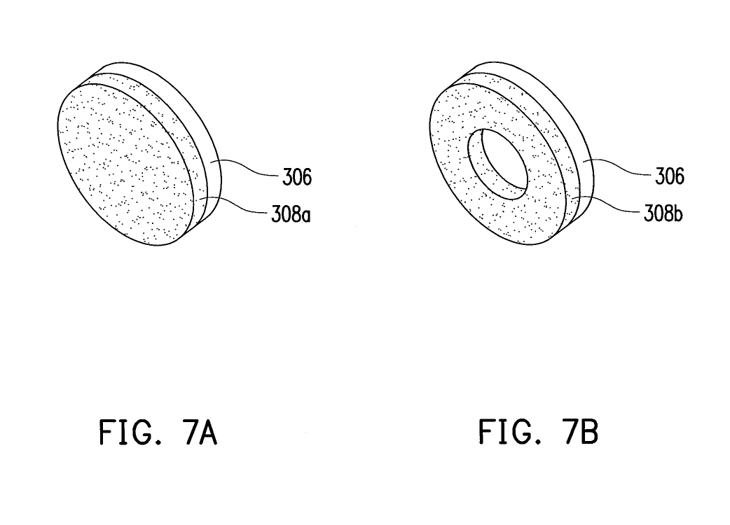

Moreover, a supporting plate can be disposed on the observe window 306 for the acid-base tank in the embodiment so that the observe window 306 for the acid-base tank is firmly disposed on the sidewall of the acid-base tank 102. The supporting plate is, for example, a transparent supporting plate 308a disposed directly on the observe window 306 for the acid-base tank (Refer to FIG. 7A). The supporting plate is, for example, an annular supporting plate 308b, disposed on the observe window 306 for the acid-base tank and exposed a portion of area of the observe window 306 for the acid-base tank (Refer to FIG. 7B).

In addition to the embodiment, the window for the acid-base tank of the present invention can further include a cover plate and an elastic connection part for the convenience of operation. In the following embodiment, the disposition of the cover plate and the elastic connection part is illustrated with the window for the acid-base tank in the second embodiment.

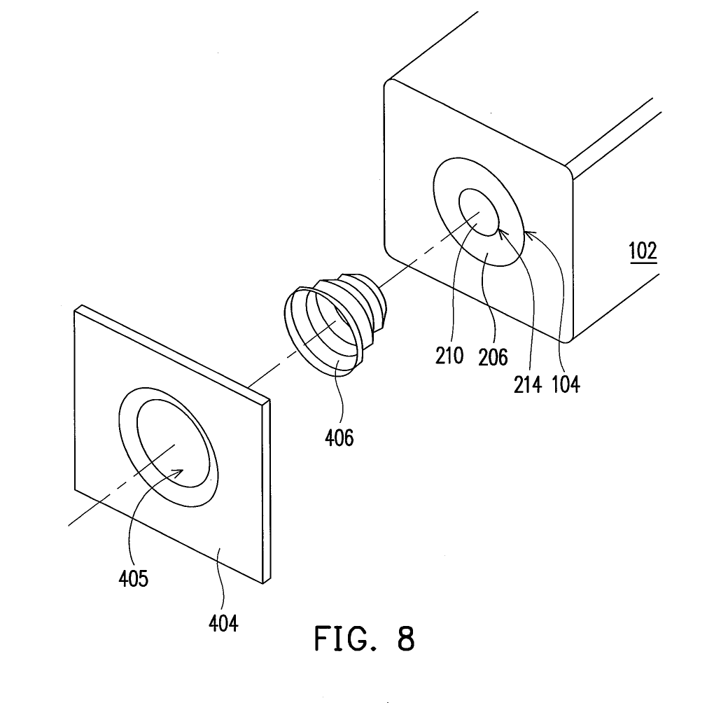

Please refer to FIG. 8. FIG. 8 is a schematic view of a window for an acid-base tank in accordance with another embodiment of the present invention. A cover plate 404 in the embodiment is disposed on the transparent observe window 210. The cover plate 404 has a second window opening 405 corresponding to the first window opening 104. Moreover, an elastic connection part 406 is used to connect the first window opening 104 and the second window opening 405.

According to the above descriptions, the window for the acid-base tank of the present invention can avoid the corrosion of window by strong acid or strong base solutions so as to cause the overflow of the cleaning solutions and affects process efficiency. On the other hand, the present invention can extend the life expand of the window of an acid-base tank and significantly lower the process costs.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A window for an acid-base tank, suitable to be disposed on a cleaning machine which at least includes an acid-base tank having an opening on the sidewall, the window for the acid-base tank at least comprising:
a supporting plate, with the same shape as the opening, disposed on the opening of the sidewall of the acid-base tank and having a first window opening;
an annular washer, disposed on the supporting plate around the first window opening;
a transparent observe window, pressing and covering on the annular washer; and
a transparent separation plate, with better chemical resistance than quartz, disposed between the supporting plate and the acid-base tank, the transparent separation plate being disposed on the supporting plate and covering the first window opening.

2. The window for the acid-base tank of claim 1, wherein the material of the transparent separation plate comprises fluoride resin material.

3. The window for the acid-base tank of claim 1, wherein the method of disposing the transparent separation plate on the supporting plate comprises using an adhering method or a coating method.

4. The window for the acid-base tank of claim 1, wherein the material of the transparent separation plate comprises quartz or glass.

5. The window for an acid-base tank of claim 1, further comprising:
a cover plate, disposed above the transparent observe window and had a second window opening which corresponds to the first window opening; and
an elastic connection part, connected the first window opening and the second window opening.

6. A window for an acid-base tank, suitable to be disposed on a cleaning machine which at least includes an acid-base tank having an opening on the sidewall, the window for the acid-base tank at least comprising:
a supporting plate, with the same shape as the opening, disposed on the opening of the sidewall of the acid-base tank and having a first window opening;
an annular washer, with chemical resistance, disposed on the supporting plate around the first window opening; and
a transparent observe window, pressed and covered on the annular washer, wherein the chemical resistance of the surface of the transparent observe window at least adjacent to a side of the opening is better than quartz.

7. The window for the acid-base tank of claim 6, wherein the material of the transparent separation plate comprises fluoride resin material.

8. The window for the acid-base tank of claim 6, wherein the transparent observe window comprises a transparent body and a transparent film, with better chemical resistance than quartz, covered on the transparent observe window.

9. The window for the acid-base tank of claim 8, wherein the material of the transparent film comprises fluoride resin material.

10. The window for the acid-base tank of claim 8, wherein the material of the transparent body comprises quartz or glass.

11. The window for the acid-base tank of claim 8, wherein the method of covering the transparent film on the transparent body comprises using an adhering method or a coating method.

12. The window for the acid-base tank of claim 6, wherein the material of the annular washer comprises plastic material fully-coated with fluoride.

13. The window for the acid-base tank of claim 6, further comprises: a cover plate, disposed above the transparent observe window and had a second window opening which corresponds to the first window opening; and
an elastic connection part, connected the first window opening and the second window opening.

14. A window for an acid-base tank which is suitable for being disposed on a washing machine having at least one acid-base tank with an opening on the sidewall, the window for the acid-base tank comprising a transparent observe window which with the same shape as the opening and is disposed on the sidewall of the acid-base tank, the transparent observe window comprising a first portion and a second portion, wherein the first portion having a first window opening is connected the sidewall of the acid-base tank, and the second portion is located in the area of the first window opening and connected the first portion, the chemical resistance of the window for the acid-base tank being better than that of quartz.

15. The window for the acid-base tank of claim 14, further comprising a supporting plate disposed on the transparent observe window.

16. The window for the acid-base tank of claim 14, wherein the material of the window for the acid-base tank comprises fluoride resin material.

17. The window for the acid-base tank of claim 14, wherein the transparent observe window is integrally formed.

18. The window for the acid-base tank of claim 14, further comprising:
a cover plate, disposed above the transparent observe window and had a second window opening which corresponds to the first window opening; and
an elastic connection part, connected the first window opening and the second window opening.
